(19) United States
(12) Patent Application Publication
(10) Pub. No.: US 2009/0032557 A1
(43) Pub. Date: Feb. 5, 2009

(54) AUTOMATIC ACTUATING DEVICE FOR SPRAYER

(76) Inventors: SHIHMING CHANG, Zhejiang (CN); Jin Jun Cao, Zhejiang (CN)

Correspondence Address: LEONG C LEI, PMB # 1008, 1867 YGNACIO VALLEY ROAD, WALNUT CREEK, CA, 94598, US

(21) Appl. No.: 11/830,860

(22) Filed: Jul. 31, 2007

(51) Int. Cl. G04C 23/00; B65D 88/54

(52) U.S. Cl. 222/644; 222/333

(57) ABSTRACT

The actuating device for a sprayer contains a control circuit to provide scheduled operations, a driving member to provide a torque, a power member to provide electricity to the control circuit and the driving member, an actuating member to exert pressure to the nozzle of the sprayer, a gear set to deliver the torque to the actuating member, and a casing member to house the foregoing components. The actuating member has a roughly quadrant shape with gear teeth on the arc and a peen besides the gear teeth. An adaptation member can be provided on top of the nozzle. The adaptation member has a socket to fit on the nozzle and a diametric elongated ridge interacting with the peen to provide closer and longer period of interaction to avoid insufficient exertion of pressure to the nozzle.

### TECHNICAL FIELD OF THE INVENTION

The present invention generally relates to sprayers, and more particularly to an actuating device engaging a sprayer to spray at scheduled times automatically.

### DESCRIPTION OF THE PRIOR ART

A conventional sprayer is operated by manually pressing a nozzle or a piston of the sprayer to pressurize the liquid contained in the sprayer to flow through a dip tube and to spray in a mist.

A sprayer is commonly found in a toilet for spraying deodorants. A preferred application of this type of sprayer is that the sprayer is actuated periodically so as to keep refreshing air in the toilet.

Conventionally an eccentric cam engaged by a motor is utilized to press the nozzle of the sprayer automatically. However, this approach has a number of disadvantages. For example, the pressure exerted by the eccentric cam is not strong enough to fully vaporize the deodorant. In addition, the deodorant is usually stored in a pressurized metallic can which presents a hazard of explosion when the sprayer is under a high temperature or undergoes significant temperature change. Furthermore, after a period of usage and as the pressure in the can drops, the sprayer would suffer a deteriorated spraying effect. After the pressure is completely gone, there will be residual deodorant that cannot be sprayed. Together with the inconvenience that the can cannot be refilled without proper equipment, the conventional sprayer is not quite economical.

### SUMMARY OF THE INVENTION

Accordingly, a novel actuating device is provided herein to obviate the shortcomings of prior arts. The actuating device for a sprayer contains a control circuit to provide scheduled operations, a driving member to provide a torque, a power member to provide electricity to the control circuit and the driving member, an actuating member to exert pressure on the nozzle of the sprayer, a gear set to deliver the torque to the actuating member, and a casing member to house the foregoing components on top of the sprayer.

The actuating member has a roughly quadrant shape with gear teeth on the arc and a peen besides the gear teeth. The peen has a curved or U-shaped contact surface with the nozzle so as to achieve an extended period of interaction between the actuating member and the nozzle.

An additional adaptation member can be provided on top of the nozzle. The adaptation member has a socket to fit on the nozzle and a diametric elongated ridge interacting with the peen to provide closer and even longer period of interaction to avoid insufficient exertion of pressure to the nozzle due to the shape of the nozzle.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the inside of an actuating device according to an embodiment of the present invention.

FIG. 2 is a perspective exploded view showing the various components of the actuating device of FIG. 1.

FIG. 3 is a sectional view showing the configuration of the actuating device of FIG. 1 before the sprayer is engaged.

FIG. 4 is a sectional view showing the configuration of the actuating device of FIG. 1 when the sprayer is engaged.

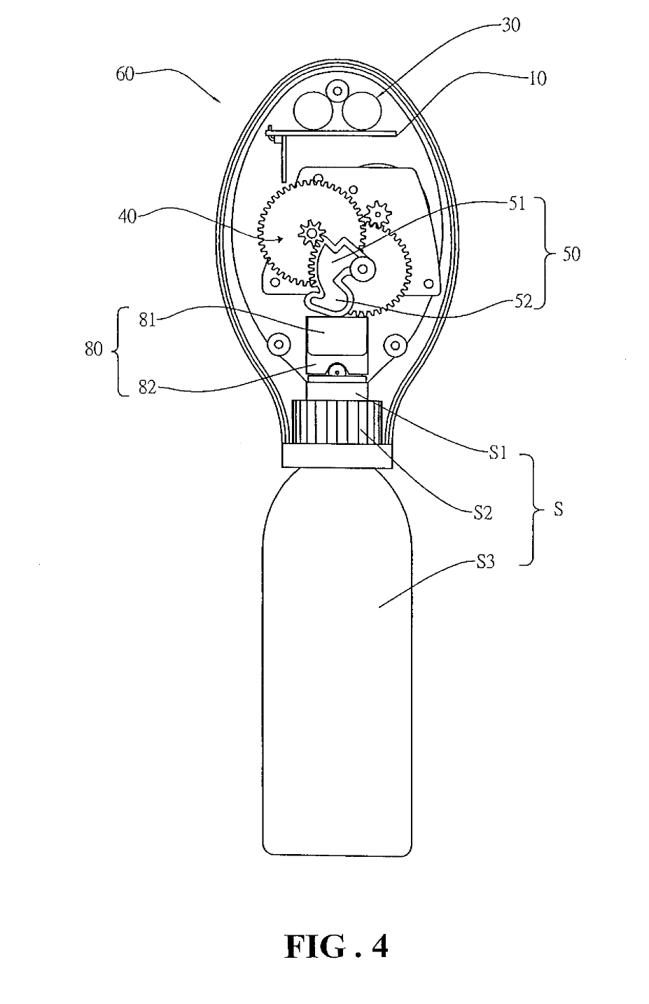

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

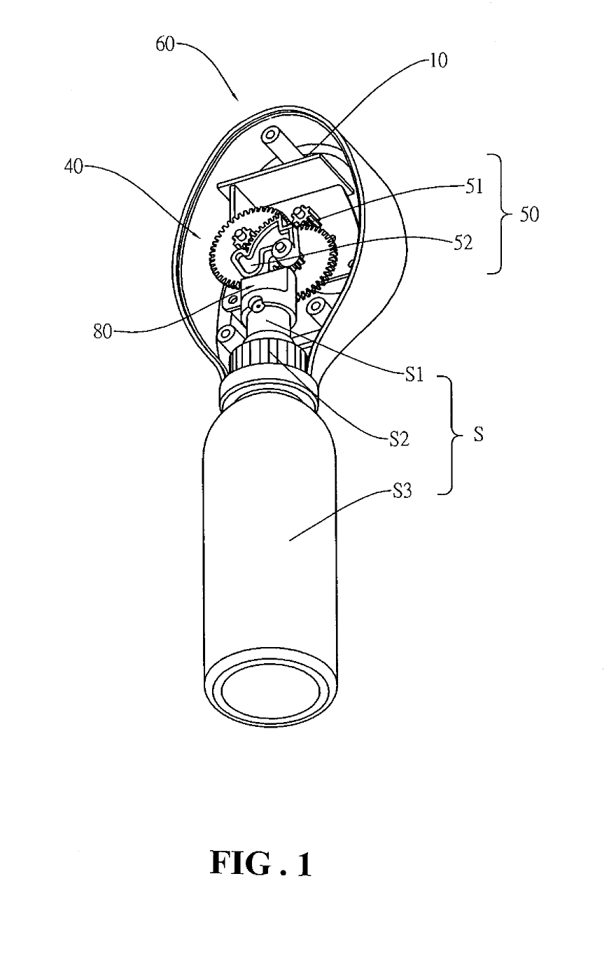

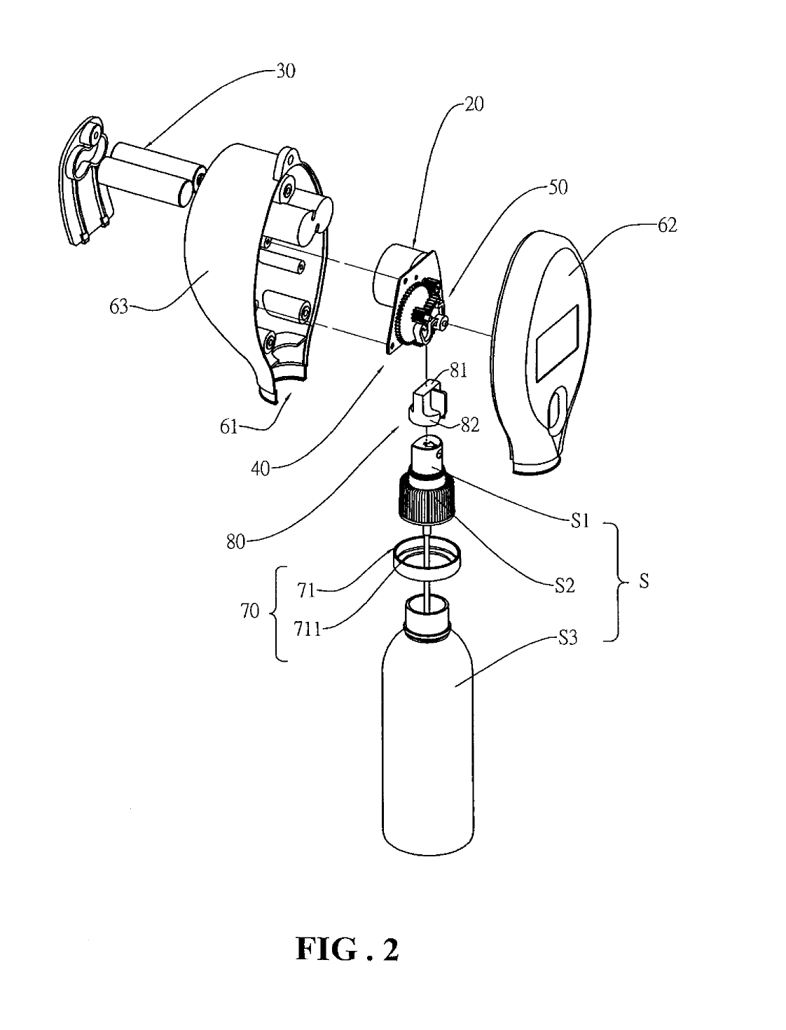

As shown in FIGS. 1 and 2, an automatic actuating device for a sprayer S according to an embodiment of the present invention contains a control circuit 10, a driving member 20, a power member 30, a gear set 40, an actuating member 50, and a casing member 60.

The control circuit 10 and the driving member 20 (e.g., a motor) are electrically connected together and both of them are also electrically connected to the power member 30 (e.g., one or more batteries) so as to receive the required electricity. The gear set 40 is physically driven by the driving member 20 so as to transmit the torque produced by the driving member 20 to the actuating member 50. The actuating member 50 has a roughly quadrant shape with gear teeth 51 along the arc which is engaged by the gear set 40 to spin (please note that the actuating member 50 is pivotally mounted at the center of the quadrant shape). To a side of the gear teeth 51, the actuating member 50 has a peen 52.

The casing member 60 is assembled by a front piece 62 and a back piece 63. The control circuit 10, the driving member 20, the power member 30, the gear set 40, and the actuating member 50 are all housed inside the space enclosed by the front and back pieces 62 and 63.

The sprayer S has a bottle S3 for the storage of the deodorant or any type of liquid. The bottle S3 has a top opening (not numbered) sealed by a cap S2 with a nozzle S1 on the top.

To install the actuating device on the sprayer S, two additional elements are required in the present embodiment. On top of the nozzle S1, there is an adaptation member 80 having a circular socket 82 for positioning the adaptation member 80 on top of the nozzle S1, and an elongated and diametric ridge 81 on top of the socket 82. The adaptation member 80 should be adjusted so that the ridge 81 is aligned in the path of movement of the peen 52.

In addition, a positioning member 70 is used to position the actuating device on the sprayer S. The positioning member 70 has a ring body 71 with a slightly larger diameter than that of the cap S2 and a flange 711 around the inner circumference of the ring body 71. The positioning member 70 is placed around the top opening of the bottle S3 and, when the cap S2 is fastened to the bottle S3, the flange 711 will be tightly pressed by the cap S2 and the positioning member 70 is securely sandwiched between the cap S2 and the bottle S3. As the ring body 71 has a slightly larger diameter than that of the cap S2, there is still some gap left between the cap S2 and the ring body 71, which is for the accommodation of a bottom opening 61 of the actuating device when the front and back pieces 62 and 63 are assembled. This way can prevent the actuating device from braking away from the sprayer S when the actuating device engages the sprayer S. The bottom opening 61 of the casing member 60 allows the cap S2, the nozzle S1, and the adaptation member 80 to stick inside the casing member 60 to interact with the actuating member 50.

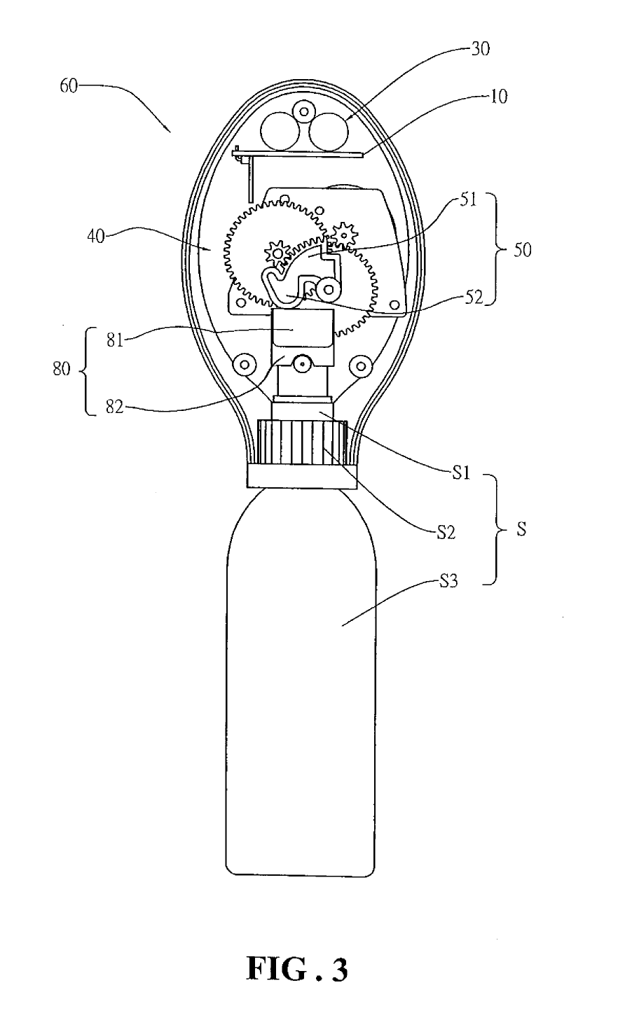

As shown in FIG. 3, when the gear set 40 is driven by the driving member 20, the gear teeth 51 of the actuating member 50 is engaged by the gear set 40 to spin counterclockwise. The peen 52 is therefore moved downward to directly press against the ridge 81 of the adaptation member 80. As the nozzle S1 is pressed along with the ridge 81, the liquid contained in the bottle S3 is sprayed. When the driving member 20 stops, the nozzle S1 restores to its original position by resilience. As the nozzle S1 rises, it pushes the peen 50 to return the adaptation member 50 back to its original position. By setting the control circuit 10 to activate the driving member 50 according to an appropriate period, the sprayer S is pressed and released automatically as described above.

The present invention has a number of advantages. First, a single-piece actuating member 50 is used and the torque produced by the driving member 20 is accurately delivered to the nozzle S1 with minimum loss. On the other hand, as the peen 52 has a curved or U-shaped contact surface with the elongated ridge 81, the interaction between the peen 52 and the ridge 81 lasts for a longer period of time than the prior arts. Therefore, the problem of insufficient exertion of pressure to the nozzle S1 is avoided and a superior spraying effect can be achieved. Moreover, the adaptation member 80 allows the actuating device to work on off-the-shelf sprayers with different shapes of nozzles S1. No specialized and pressurized can is required and an ordinary user can refill the sprayer any time. The separation of the casing member 60 into front and back pieces 62 and 63 also offers advantages such as easier assembly, maintenance, and manufacture.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An actuating device for a sprayer, said sprayer having a nozzle on top of an opening of a bottle for spraying the liquid stored in said bottle in a mist, said actuating device comprising:
a driving member capable of producing a torque;
a control circuit electrically connected to said driving member to provide periodic activation to said driving member;
a power member electrically connected to said driving member and said control circuit to provide electricity to said driving member and said control circuit;
a gear set engaged by said driving member;
an actuating member having a roughly quadrant shape with a plurality of gear teeth along the arc of said quadrant shape and a peen besides said gear teeth wherein said peen is spun as said gear teeth are engaged by said gear set; and said peen has a contract surface to exert pressure on said nozzle; and
a casing member housing said driving member, said control circuit, said power member, said gear set, and said actuating member, wherein said casing member is positioned on top of said opening of said bottle; and said casing member has an opening to allow said nozzle to stick into said casing member and interact with said actuating member.

2. The actuating device according to claim 1, wherein said contact surface of said peen is curved.

3. The actuating device according to claim 1, wherein said contact surface of said peen is U-shaped.

4. The actuating device according to claim 1, further comprising an adaptation member positioned on top of said nozzle wherein said peen exerts pressure on said nozzle through said adaptation member.

5. The actuating device according to claim 4, wherein said adaptation has a socket for fitting on said nozzle and an elongated ridge on top of said socket to interact with said peen.

6. The actuating device according to claim 5, wherein said ridge is aligned in the path of movement of said peen.
